(19) United States
(12) Patent Application Publication
(10) Pub. No.: US 2008/0193272 A1
(43) Pub. Date: Aug. 14, 2008

(54) PROCESS FOR DEPALLETIZING GOODS

(75) Inventor: Randy R. Beller, Beaumont, TX (US)

Correspondence Address: FULBRIGHT & JAWORSKI L.L.P, 2200 ROSS AVENUE, SUITE 2800, DALLAS, TX, 75201-2784, US

(73) Assignee: Sage Automation, Inc., Beaumont, TX (US)

(21) Appl. No.: 11/672,661

(22) Filed: Feb. 8, 2007

(51) Int. Cl. B65G 59/04

(52) U.S. Cl. 414/797; 414/798.7; 414/806

(57) ABSTRACT

The present invention is directed to a system and method for automating the depalletization process. A vacuum hood is used to capture palletized goods one layer at a time using slip sheets that form barriers between the layers of goods stacked on a pallet. The walls of the vacuum hood form a seal with the slip sheet in order to seize the goods within the vacuum hood and remove the goods from the pallet. Each layer of goods may then be deposited on a conveyor system where the slip sheet is removed and the goods can be further processed or subdivided using conventional conveyor separation and alignment techniques.

### TECHNICAL FIELD

The present invention relates generally to a method and systems for removing items that are stacked on a pallet and more particularly to a method and systems for removing items that are stacked on a pallet by using vacuum power to remove items from the pallet and a conveyor system to further process the items once the items are removed from the pallet.

### BACKGROUND OF THE INVENTION

Pallets are portable platforms on which goods are placed for storage or transport. Pallets are usually designed to allow forklifts or other industrial movers to efficiently transport the pallets, which in turn facilitates the movement of large quantities of goods. Goods of significant size can encompass an entire pallet while smaller goods can be arranged in various configurations so as to maximize the number of goods that can placed on each pallet. Such configurations may utilize layering techniques in which multiple goods can be arranged on the bottom layer while additional layers of goods are stacked on top of the bottom layer and so forth. Depending on the height of the goods to be stored or transported, a pallet may contain multiple layers of goods, the total capacity of a pallet being potentially limited by such factors as the size and weight of individual goods as well as considerations related to the storage, transport, loading, and unloading of goods. A load may consist of one or more layers of product and may be unitized (no pallet) or palletized (pallet).

In a typical situation, cartons containing goods are arranged on a pallet in a uniform pattern to facilitate the layering of goods. For example, a pallet may have the capacity to accommodate four rows of four cartons for a total of sixteen cartons that might comprise the bottom layer. Once the bottom layer is complete, sixteen additional cartons may be stacked on top of the original sixteen cartons to form another layer of cartons. Additional layers of cartons are then added until the pallet reaches predetermined height or weight limitations. While the foregoing example describes a scenario in which cartons of regular shape (e.g., cube-shaped) are stored on a pallet, irregularly-shaped goods can also be stored and transported using pallets. However, the arrangement of irregularly-shaped goods often provides additional challenges to maximizing pallet capacity as well as to the efficient removal of such goods from the pallet.

Once a pallet of goods had reached its destination, the goods on the pallet can be removed from the pallet either manually or through the use of equipment that can facilitate the unloading of the pallet. For example, pallets may be moved through the use of forklifts or hand-drawn jacks. When goods are heavy or unwieldy so as to prevent manual unloading, the blades of the forklift may be used to lift one or more products from the pallet by inserting the blades underneath the product or by raising the product from above using chains attached to the blades. In either scenario, a procedure to insert the blades or chain underneath the product without greatly increasing the likelihood of damaging the palletized goods becomes necessary. The use of slip sheets or other dividers to separate one layer of goods from the next has been implemented to effect some demarcation between layers and to reduce to some extent the danger of damaging the goods during the depalletization process. Slip sheets also act to stabilize a palletized or unitized load during transport because column stacking products on pallets (i.e., without slip sheets) often creates loads that are unstable. However, even when such procedures are implemented, safety issues may arise due the relative instability of the carton while it is being unloaded.

On the other hand, when the goods weigh relatively little, the goods are capable of being removed from the pallet manually. However, having a worker manually unload the goods from a pallet remains relatively inefficient and workers can be injured when attempting to unload heavy or unwieldy goods or merely by using the incorrect body mechanics when removing the goods from the pallet. Common health issues that are implicated include carpal tunnel syndrome, repetitive movement injuries, and various muscle (e.g., back) injuries. Further, although the manual unloading of goods from pallets onto store shelves may be appropriate in a retail scenario, when large volumes of palletized goods need to be unloaded quickly and efficiently for automated storage and/or processing applications, the manual unloading of such pallets is usually undesirable with respect to labor costs, reliability, and speed attributed to the pallet unloading process, or “depalletization” process. This will generally be true whether the goods are regularly-shaped or irregularly-shaped.

Proposed solutions that have been explored to facilitate the automation of the depalletization process have met with varying degrees of success based to some degree on the non-standard array of goods that can be stored and/or transported on pallets. For example, depalletization methods that may be utilized to remove large cartons (e.g., 8 cartons per pallet) may not be effective in removing smaller cartons (e.g., 1000 cartons per pallet). Irregular shaped goods provide additional challenges to the development of a universal yet efficient method for unloading pallets. Many products such as stacks of loose cartons, open top boxes, boxes with weak tops, and boxes with slip-on tops have provided challenges to the development of a standard method and system for depalletizing products. Prior methods aimed at improving the depalletization process include the use of custom slip sheets that have a matrix of bumps or an array of corrugations to permit small forks to get under the product. However, this method has its disadvantages in the expense associated with the custom slip sheets and the automation necessary to detect the bumps or corrugations so that the forks can be properly inserted to prevent damage to the palletized goods. Although the emergence of pallets revolutionized the material handling industry by allowing more goods to be loaded and unloaded faster with less labor, a parallel efficiency in the depalletization of goods has yet to be realized.

### BRIEF SUMMARY OF THE INVENTION

The present invention claims a system that uses a vacuum hood to remove goods from a pallet a layer at a time along with a slip sheet that separates each layer of goods. The system is comprised of a vacuum hood that is lowered down onto the topmost layer of palletized goods. The vacuum hood forms a seal with the slip sheet so that the goods can be removed from the pallet along with the slip sheet once the vacuum is turned on. Effectively, the vacuum hood and the slip sheet form a container in which the layer of goods is contained, which is then moved off of the pallet. The system is further comprised of a conveyor system where the vacuum hood places layers of goods. The conveyor system is made up of at least two independent conveyor sections so that the slip sheet may be removed between a space between the conveyor sections while the goods continue along conveyor system. There are a number of techniques and associated equipment that can be used to guide the slip sheet through the space so that it can be removed from the system. After the slip sheet is removed, the goods may then continue along the conveyor system for further processing without the slip sheet.

The present invention also claims a method in which each layer of palletized goods are removed from the pallet along with a slip sheet that separates each layer of goods. The goods are removed using vacuum power from a vacuum hood. Once the vacuum hood is lowered down onto the top layer of palletized goods, the vacuum hood will form a seal with the slip sheet. Once the vacuum power is turned on, the vacuum hood removes the captured layer of goods from the pallet. The vacuum hood can then place the goods and the slip sheet onto a conveyor system. Once the goods and slip sheet are placed on the conveyor system, the slip sheet can then be removed through a space between conveyor sections so that the goods can continue along the conveyor system for further processing without the slip sheet.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view of a portion of the present invention showing an embodiment of a vacuum hood;

FIG. 2 is a perspective view of the interior of a vacuum hood in one embodiment of the invention;

FIG. 3 is a perspective view of a portion of the present invention illustrating a vacuum hood used to depalletize goods;

FIGS. 4A-4D are front views of an embodiment of the invention in which a vacuum hood is used to depalletize a layer of goods;

FIGS. 5A-5E are side views of a conveyor system where goods being placed onto the conveyor system;

FIGS. 6A-6C are side views of a conveyor system illustrating exemplary embodiments that act to remove the slip sheet from the conveyor system;

FIGS. 7A-7C are side views of a conveyor system illustrating a slip sheet being removed from a conveyor system; and

FIG. 8 is a perspective view of a layer of goods traveling along the conveyor system.

### DETAILED DESCRIPTION OF THE INVENTION

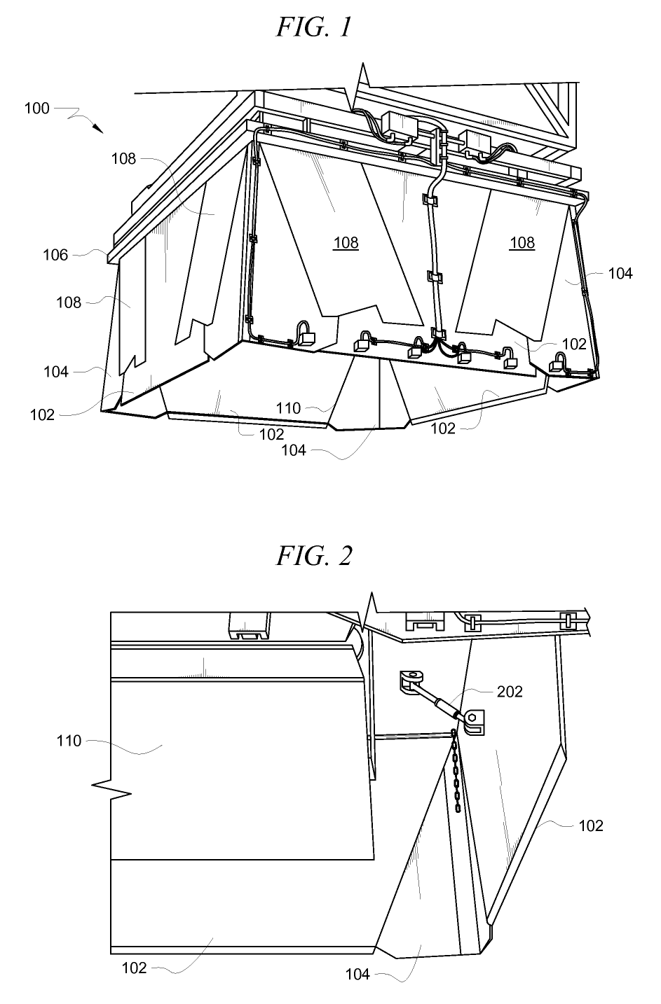

FIG. 1 shows an embodiment of vacuum hood 100, which is partially comprised of four main side walls 102 and four corner members 104. Although some embodiments of vacuum hood 100 are described herein, it is to be expressly understood that the scope of the available embodiments relating to vacuum hood 100 is more completely described in commonly assigned patent application Ser. No. 11/358,672 entitled “LAYER PICKING END EFFECTOR,” the disclosure of which application is expressly incorporated herein by reference, though vacuum cups as used in the incorporated reference are not required in any embodiment of the present invention. In one embodiment of the invention, side walls 102 are connected to compliance float 106, which may be square or rectangular in shape. Typically, side walls 102 are attached to compliance float 106 or similar platform using hinges or other attachment means such that side walls 102 may pivot inward or outward to retract or expand the range of vacuum hood 100.

Each of side walls 102 may be expanded or retracted individually so that vacuum hood 100 can accommodate a range of palletized products without retooling. For example, side walls 102 may fold inward to facilitate the capture of a layer of goods that encompasses an area less than that of vacuum hood 100. Side walls 102 on opposite sides of vacuum hood 100 may be closed and opened with synchronized motion. In a preferred embodiment, if a target layer of goods is not initially centered underneath vacuum hood 100, compliance float 106 allows vacuum hood 100 to be repositioned so that the goods may be removed. Guide plates 108 are located on the sides of vacuum hood 100, forming slots for corner members 104.

Compliance float 106 allows vacuum hood 100 to move and accommodate pallets that have layers misaligned in relation to the position of vacuum hood 100. Individual layers of goods can be located off center due to rough handling by a supplier or shipper. Therefore, compliance float 106 allows vacuum hood 100 to “float” and center itself properly over the layer of goods to be depalletized. Once vacuum hood 100 is properly aligned and placed over the layer of goods to be depalletized, ceiling 110 is lowered down onto the goods. Ceiling 110 may be flat or may comprise one or more attachments that can be used to fill in large voids in a patterned layer to be depalletized.

In one embodiment of the invention, the system uses a suction generator to pump air out of vacuum hood 100, which creates sufficient negative pressure to facilitate the capture of layers of palletized goods lift the product layer. During the depalletizing process, air should be suctioned continuously from vacuum hood 100, which acts to provide constant negative pressure that is sufficient to lift the weight of the goods being removed from the pallet. The line of atmospheric change is located at the bottom of the layer of goods to be depalletized and the product is effectively pushed into vacuum hood 100 by the higher atmospheric pressure. In a preferred embodiment, side walls 102 are stiff or have limited flexibility. A stiff wall typically provides added friction to the interaction between the goods and vacuum hood 100. In certain embodiments, side walls 102 provide additional clamping force because the vacuum power acts to draw in side walls 102 toward the center of vacuum hood 100.

In one embodiment of the invention, vacuum hood 100 may be configured to automatically detect slip sheets placed between layers of goods. One or more pressure transducers may also be mounted on vacuum hood 100 in order to monitor vacuum pressure within vacuum hood 100 and maintain a predetermined vacuum pressure level. Some pressure leakage may occur within the system and each layer of goods may have a leakage factor varying from the norm. Because a good seal may not be possible, a high flow, low pressure blower that allows for significant air leaks may be used so that leaks do not cause dramatic drops in pressure. To provide a constant lifting force under conditions of unpredictable leakage, a pressure transducer can be used to measure the negative pressure in vacuum hood 100. The pressure transducer may be utilized as a feedback mechanism in a closed-loop control system to ensure that the pressure is maintained at or near optimum levels. For example, if the pressure transducer detects that the negative pressure level is insufficient, the vacuum generating source will receive a signal to increase the vacuum pressure within vacuum hood 100. Conversely, if the pressure transducer detects that the negative pressure level is unacceptably high, then the vacuum generating source will receive a signal to decrease the vacuum pressure within vacuum hood 100.

In a preferred embodiment, collision sensors are incorporated into vacuum hood 100 so that collisions between vacuum hood 100 and other objects can be immediately detected to prevent further damage. In this embodiment, the activation of the collision sensor may act to trip an emergency stop circuit that automatically stops movement of vacuum hood 100 and may also issue a warning signal to the operator of vacuum hood 100.

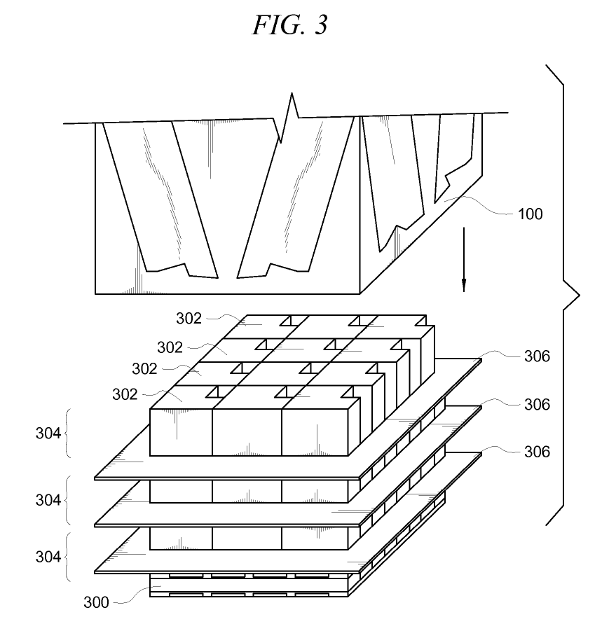

FIG. 2 shows an embodiment of ceiling 110, which is coupled to a vacuum generating source that provides the necessary pressure once the system is engaged. Side walls 102 may be moved outward or inward by using fluid power, such as pneumatic power or hydraulic power, to pivot side walls 102 during the depalletization process. As shown in FIG. 2, piston 202 is mechanically attached to side wall 102. Piston 202 can be controlled by the operator of vacuum hood 100 to either move side walls 102 outward or retract side walls 102 inward towards the center of vacuum hood 100. This allows vacuum hood 100 to change its configuration if such change is determined to be advantageous to the depalletization process.

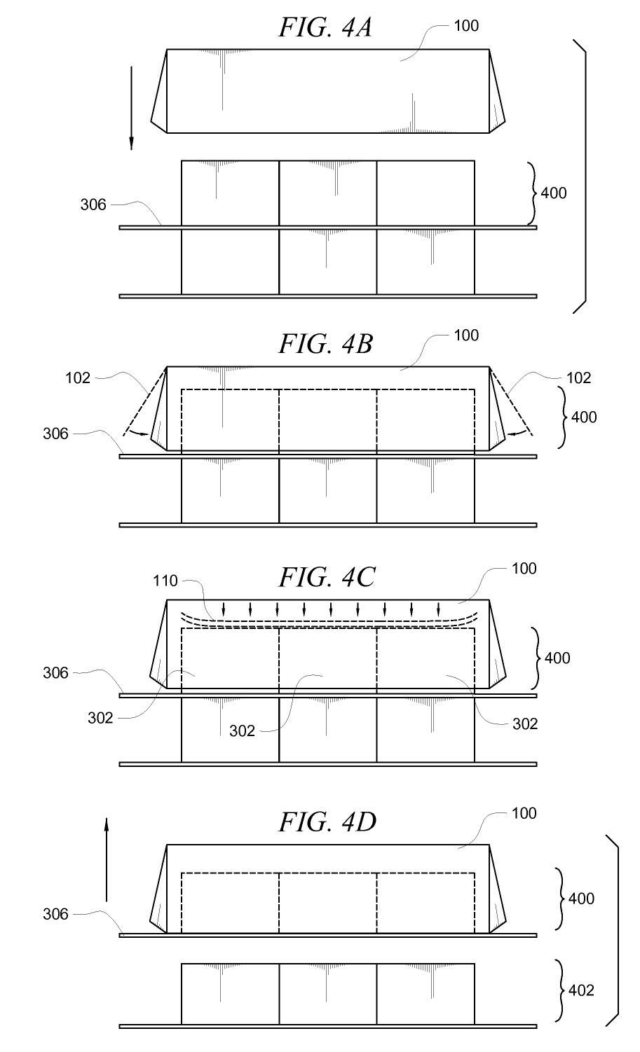

FIG. 3 shows an embodiment of the invention in which vacuum hood 100 is shown hovering above a typical load to be depalletized. This example shows pallet 300 with three layers of goods that are arranged in a rectangular configuration with each layer containing products 302 that are arranged in three rows of four (3×4) for a total of twelve (12) products on each layer 304. The goods in this example are somewhat irregularly shaped and are not contained in traditional six-sided cartons. The invention is not limited to handling traditional cartons or other commonly-shaped packages and is able to perform the depalletizing procedure whether the goods are packaged in standard cartons or irregularly-shaped containers. Further, product such as stacks of paper, stacks of flattened cartons, or stacks of cardboard may also be depalletized using the present invention.

As shown in FIG. 3, vacuum hood 100 is shown hovering over pallet 300, which could have been deposited under vacuum hood 100 by a forklift, for example, or vacuum hood 100 could have been actuated so that it rested directly over pallet 300 in order to begin the unloading process. Various embodiments of the invention are available with respect to movement of the vacuum hood, such as a robotic arm, a manual assisted manipulator that allows a system operator to move the vacuum hood, or a fork truck on which vacuum hood 100 may be mounted. In another embodiment, an overhead crane system allows the vacuum hood to travel along what is primarily a predetermined path from the pallet to the conveyor system. In other embodiments, a combination of such systems may be used in conjunction with one or more staging areas where goods can be stored after removal from the pallets but before being placed on the conveyor system.

Each slip sheet 306 has a surface area that ideally extends beyond the area occupied by product 302 in order to facilitate the seal formed between vacuum hood 100 and slip sheet 306. The composition of slip sheets may be dependent on the nature of the goods being depalletized or the method or methods of slip sheet removal implemented in the embodiment of the invention. Slip sheets may be composed of materials selected for such characteristics as stiffness or flexibility. For example, one embodiment of the invention may use slip sheets made out of corrugated material so that the slip sheet is flexible in one plane and stiff in the perpendicular plane. This placement of slip sheet 306 allows vacuum hood 100 to be lowered onto the topmost layer of the pallet and form a seal with slip sheet 306, which effectively creates an enclosure in which the goods can be removed from pallet 300. Each slip sheet 306 forms a barrier between each layer of stacked goods and can vary in its composition to allow for flexibility or rigidity depending on the nature of the palletized goods and the embodiment of the invention being practiced. The slip sheets are inserted between the each layer when the goods are initially loaded onto the pallet. Further, a slip sheet should be inserted between the top of the pallet and the bottom layer of goods so that the bottom layer can be unloaded in the same manner as the upper layers.

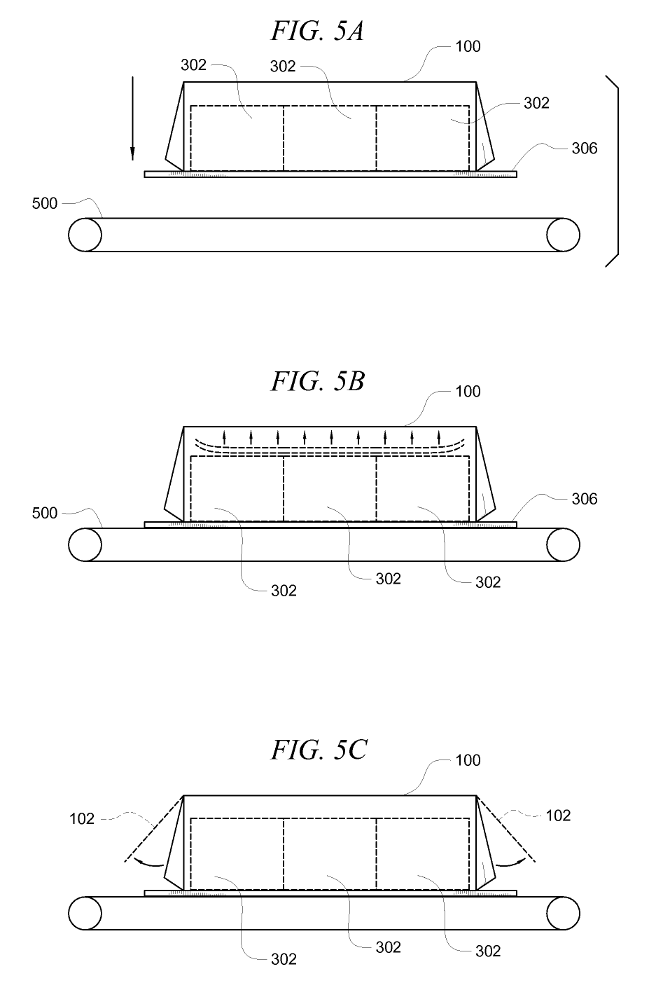

FIGS. 4A-4D are front views of an embodiment of the invention in which vacuum hood 100 is used to depalletize a layer of goods. FIG. 4A shows vacuum hood 100 being lowered down onto topmost layer 400 of goods to be unloaded, which consists of two layers of goods that are separated by slip sheet 306. FIG. 4B shows the walls of vacuum hood 100 making contact with slip sheet 306 and thereby capturing topmost layer 400 within vacuum hood 100. In effect, slip sheet 306 becomes the bottom of the transport container comprised of vacuum hood 100 and slip sheet 306. In the embodiment shown in FIG. 4B, side walls 102 of vacuum hood 100 are actuated so as to clamp down on topmost layer 400 while forming a seal with slip sheet 306.

As shown in FIG. 4C, once vacuum hood 100 is properly positioned over topmost layer 400, ceiling 110 of vacuum hood 100 is lowered down to the top of topmost layer 400. If the goods are irregularly shaped or the stack pattern leaves large voids within the palletized configuration, it may be desirable to insert retainers to fill these voids. In this embodiment, such retainers may be made from a variety of materials depending on the application and may be necessary to prevent an otherwise flexible slip sheet from wrinkling. Retainers maybe brought down in conjunction with the ceiling 110 of vacuum hood 100 being lowered down onto topmost layer 400.

When vacuum hood 100 is properly positioned so that the all of the walls of vacuum hood 100 form a seal with slip sheet 306, the vacuum is turned on. An airtight seal is not necessary and may not be practical or possible depending on the embodiment of the claimed invention. Top layer 400 is secured by the seal created by the vacuum between vacuum hood 100 and slip sheet 306. In one embodiment of the invention, the amount of vacuum pressure exerted on the goods is regulated such that the vacuum pressure used is exactly the vacuum pressure needed to effectively practice the claimed invention and no more. As shown in FIG. 4D, once topmost layer 400 has been captured by vacuum hood 100, the captured goods can then be removed from the pallet as vacuum hood 100 lifts slip sheet 306 and topmost layer 400 off of the pallet. The next layer of goods 402 directly below topmost layer 400 becomes the next topmost layer for unloading purposes so that once vacuum hood 100 has moved topmost layer 400 to its next destination, it can repeat the process by capturing the next layer of goods until the pallet has been completely unloaded.

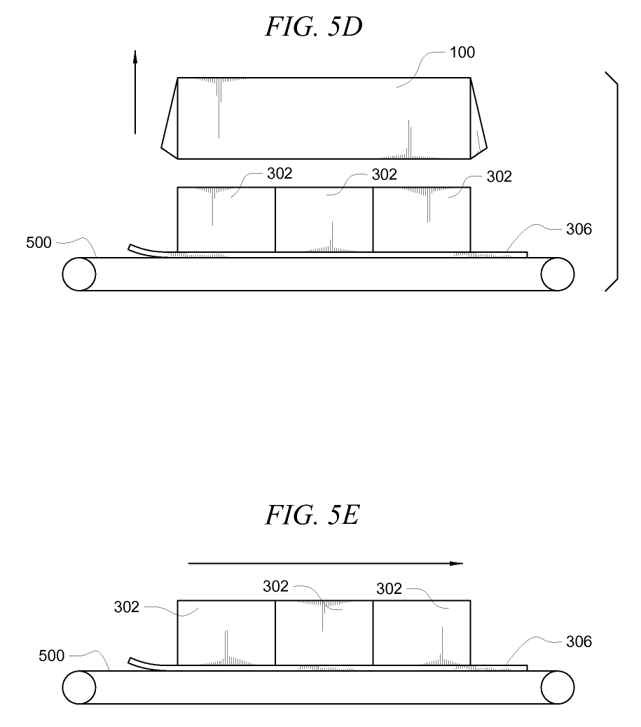

FIGS. 5A-5E are illustrations showing a depalletized layer of goods being unloaded onto a conveyor system. In this embodiment, the goods are moved directly from the pallet an onto the conveyor system. In other embodiments of the invention, the goods are unloaded from the pallet and placed in a staging or storage area before being placed onto the conveyor system. The unloading of pallets by layer and their eventual processing by the conveyor system are therefore not necessarily consecutive events as the vacuum hood may unload pallets and place the depalletized goods in a staging area for subsequent placement on the conveyor system when the goods are needed by the enterprise or the conveyor system is available. Also, different processing methods may need different tooling depending on the goods being conveyed. Tooling changes may take time to implement so direct transfer of the goods from the pallet to the conveyor system may not be desirable.

As shown in FIG. 5A, once the depalletized layer of goods has been transferred by vacuum hood 100 to the conveyor system, the goods are placed onto conveyor section 500 for further processing. Product 302 and slip sheet 306 are lowered down onto conveyor section 500. In the illustrated embodiment, conveyor section 500 is initially stopped to allow the goods to be placed onto conveyor section 500 by vacuum hood 100. As shown in FIG. 5B, once product 302 and slip sheet 306 have been deposited onto conveyor section 500, the vacuum is turned off and ceiling 110 of vacuum hood 100 is raised. If retainers were used to fill voids caused by irregularly shaped goods and packaging, these retainers may be retracted along with ceiling 110 at this point in the process.

As shown in FIG. 5C, side walls 102 are retracted so as to further disengage product 302 from vacuum hood 100. FIG. 5D shows vacuum hood 100 being raised off of product 302 and slip sheet 306 now that the goods have been released. Vacuum hood 100 is then free to capture the next layer of goods to be depalletized or otherwise retrieve the next layer from a storage or staging area, while product 302 and slip sheet 306 remain on conveyor section 500 for further processing. As shown in FIG. 5E, once product 302 and slip sheet 306 have been placed on conveyor section 500, the conveyor may be activated to move the layer of goods towards the slip sheet removal portion of the conveyor system. The conveyor system may be comprised of various types of conveyors such as belt conveyors, belt-driven roller conveyors, line-shaft driven roller conveyors, or motorized roller conveyors depending on the nature of the goods and the downstream processing to be performed. For exemplary purposes, the specification will primarily describe the invention with respect to an embodiment using one or more belt conveyors with varying characteristics.

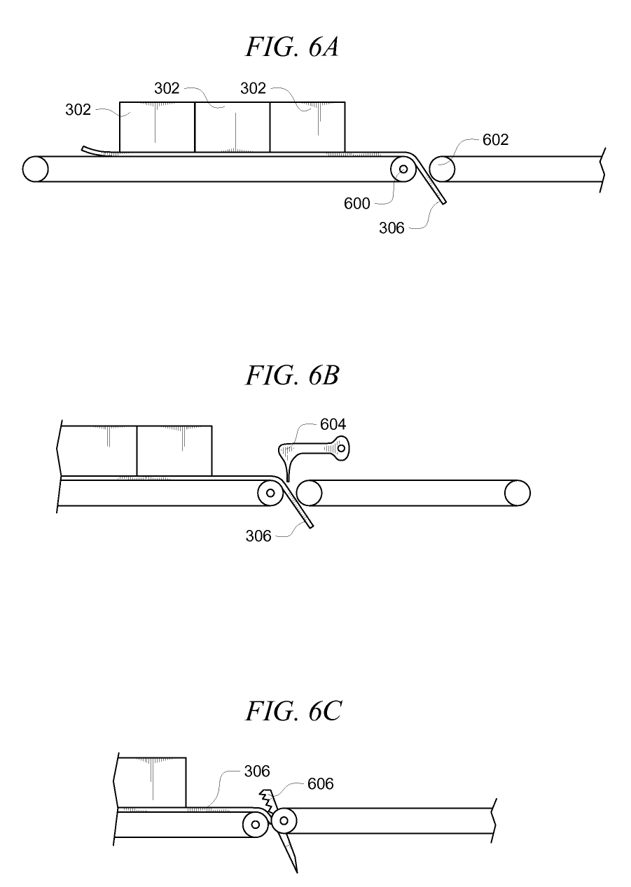

FIGS. 6A-6C are side views of a conveyor system illustrating exemplary embodiments that act to remove the slip sheet from the conveyor system. The exemplary embodiments shown can be used separately or in combination with each other or other embodiments of the invention directed towards removing slip sheets. FIG. 6A shows an embodiment that uses vacuum roller 600 to remove slip sheet 306 from the conveyor system, comprised of two sections in this embodiment. Vacuum roller 600 uses suction ports that exert vacuum power through holes in the conveyor belt. This allows vacuum roller 600 to pull the leading edge of slip sheet 306 down between vacuum roller 600 and lead roller 602 of the next conveyor section. In this embodiment of the invention, slip sheet 306 is removed from the conveyor system while product 302 continues along the conveyor system as product 302 is transferred from one conveyor section to the next. FIG. 6B shows an alternative embodiment of the slip sheet removal process that uses mechanical stuffer 604 to push slip sheet 306 through the gap between the rollers of the two adjacent conveyor sections. FIG. 6C shows another embodiment of the slip sheet removal process that uses “clamp and pull” mechanism 606 that clamps down on the leading edge of slip sheet 306 and draws slip sheet 306 down through the gap between the rollers of the two adjacent conveyor sections.

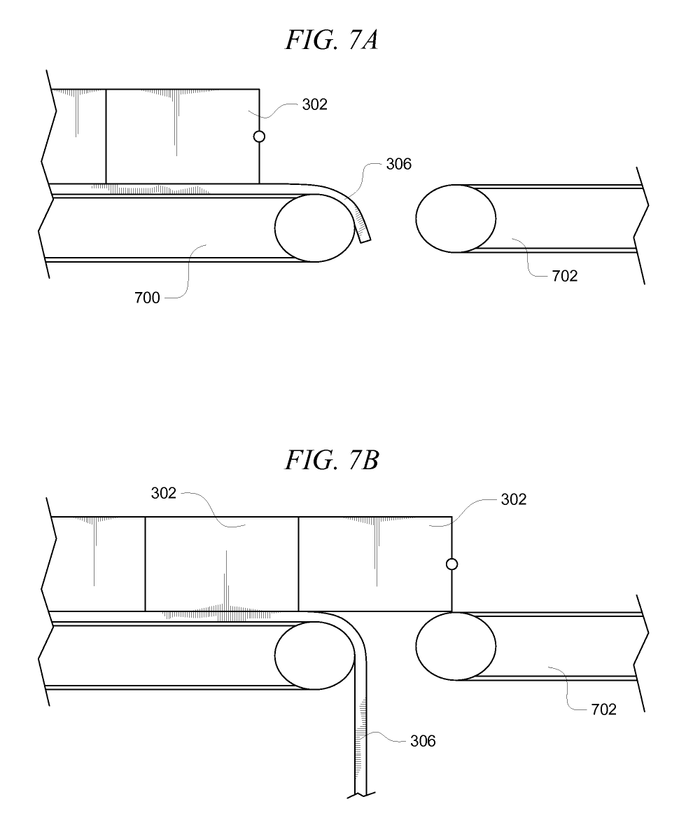

FIGS. 7A-7C are side views of a conveyor system illustrating a slip sheet being removed from a conveyor system. In FIG. 7A, slip sheet 306 and products 302 are moving along conveyor 700. Although FIG. 7A and FIG. 7B appear to show a single product from the side view, it is to be expressly understood that the system is processing the layer of products that were depalletized and eventually deposited on the conveyor system. As products 302 move along conveyor section 700 toward conveyor section 702, products 302 are situated on slip sheet 306 in the same configuration in which products 302 were originally deposited on the conveyor system.

As indicated in FIG. 7A, the leading edge of slip sheet 306 is directed down towards the gap between conveyor section 700 and conveyor section 702. This can be accomplished through a variety of methods, which can include the embodiments described above (e.g., vacuum roller, mechanical stuffer, “clamp and pull” mechanism, or possibly even a combination of extraction methods). As slip sheet 306 is directed down towards the gap to be effectively removed from the conveyor system, product 302 is of such bulk and the gap between conveyor sections sufficiently narrow that product 302 continues across the gap and onto conveyor section 702 without slip sheet 306, which is eliminated from the conveyor system as the goods pass over the gap between conveyor sections.

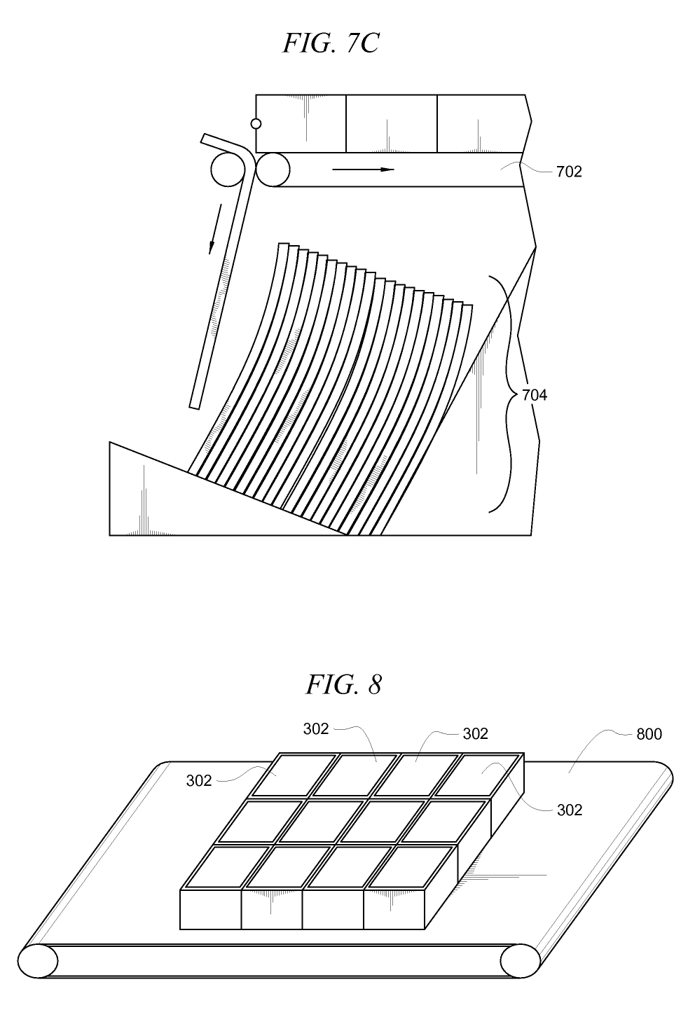

FIG. 7B shows the leading edge of product 302 continuing across the gap between the conveyor sections. Similarly, slip sheet 306 is being removed from the conveyor system at the same time that products 302 are continuing along conveyor section 702. FIG. 7C illustrates an embodiment of the end of the slip sheet removal process as the last products are conveyed onto conveyor section 702 and slip sheet 306 is deposited into hopper 704. Slip sheets 306 may be collected, stored, or prepared for recycling once reaching hopper 704 or whatever storage or processing system is adapted to deal with the intake of slip sheet 306 from the conveyor system. FIG. 8 shows an example of products 302 being conveyed along conveyor section 800 with no slip sheet remaining from the depalletizing process. Once the slip sheet has been removed, the products are then able to be processed in the layer configuration shown in FIG. 8, or can be processed by row, column, or individually using a variety of widely known conveyor separation techniques that may be used to change the configuration of the products as they move along the conveyor system.

The conveyor separation techniques that may be used to sort, separate, or otherwise align the goods for efficient downstream processing are highly dependent on the nature of the goods (e.g., size, shape, weight) and the nature of the downstream processing, if any. Embodiments of the present invention comprise methods and systems that are designed to handle high volumes of the same or similar goods that have the same or similar characteristics as well as goods that do not share the same physical or packaging characteristics. Such considerations may affect the selection of the conveyor separation technique employed in this embodiment of the invention.

For example, if the goods are moving along the conveyor system in a side by side configuration such as that shown in FIG. 8, but the preferred orientation of product is a single line, then conveyor separation techniques and systems may be used to facilitate this process. Such a system might consist of a conveyor using a plurality of parallel belts that are separated by blocks that may be raised above the belt surface to temporarily stop the movement of one or more rows of product while allowing a single row to progress down the conveyor belt. Once the first row has continued down the conveyor belt, the block may be lowered to allow the temporarily stopped product to resume moving along the conveyor system. Further, a mechanical alignment mechanism that uses rollers and angled sidewalls may be used to properly align the subsequent rows that continue along the conveyor system so that the alignment matches that of the initial row that was initially allowed to proceed. The above-described embodiment is an example of one of the myriad of conveyor techniques that can be used to change the configuration and orientation of the depalletized goods as they progress along the conveyor system to their final destination, wherever that may be.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for processing palletized goods in which a slip sheet divides each layer of goods on a pallet, said system comprising:
a vacuum hood;
a conveyor system comprising at least a first conveyor section and a second conveyor section with a space between said first conveyor section and said second conveyor section; and
means for guiding each slip sheet through said space,
wherein said vacuum hood removes each layer of goods and each slip sheet from a pallet and places the goods on said conveyor system in which each slip sheet is removed from said conveyor system though said space between said first conveyor section and said second conveyor section.

2. The system of claim 1 wherein means for guiding each slip sheet through said space is a vacuum roller at the end of said first conveyor section that draws each slip sheet into said space between said first conveyor section and said second conveyor section.

3. The system of claim 1 wherein means for guiding each slip sheet through said space is a mechanical stuffer to push each slip sheet into said space between said first conveyor section and said second conveyor section.

4. The system of claim 1 wherein means for guiding each slip sheet through said space is a “clamp and pull” mechanism that clamps down on each slip sheet and pulls each slip sheet into said space between said first conveyor section and said second conveyor section.

5. The system of claim 1 further comprising a staging area where each layer of goods is stored prior to being placed on said conveyor system.

6. The system of claim 1 further comprising a hopper where each slip sheet is stored after being removed from said conveyor system through said space between said first conveyor section and said second conveyor section.

7. A system for processing palletized goods in which a slip sheet divides each layer of goods on a pallet, said system comprising:
means for removing each layer of goods and each slip sheet from a pallet and placing each layer of goods and each slip sheet onto a conveyor section;
a conveyor system comprising more than one conveyor section upon which each layer of goods is placed; and
means for removing each slip sheet from said conveyor system by guiding each slip sheet through a space between said conveyor sections as goods move from one conveyor section to the next.

8. The system of claim 7 wherein means for removing each layer of goods and each slip sheet from a pallet and placing each layer of goods and each slip sheet onto a conveyor section is a vacuum hood.

9. The system of claim 7 wherein means for removing each slip sheet from said conveyor system by guiding each slip sheet through a space between said conveyor sections as goods move from one conveyor section to the next is a vacuum roller.

10. The system of claim 7 wherein means for removing each slip sheet from said conveyor system by guiding each slip sheet through a space between said conveyor sections as goods move from one conveyor section to the next is a mechanical stuffer.

11. The system of claim 7 wherein means for removing each slip sheet from said conveyor system by guiding each slip sheet through a space between said conveyor sections as goods move from one conveyor section to the next is a “clamp and pull” mechanism.

12. The system of claim 7 further comprising means for recycling each slip sheet after each slip sheet is removed from said conveyor system.

13. A system for processing palletized goods in which a slip sheet divides each layer of goods on a pallet, said system comprising:
means for removing each layer of goods and each slip sheet from a pallet;
means for placing each layer of goods and each slip sheet onto a conveyor section;
a conveyor system comprising more than one conveyor section upon which each layer of goods is placed; and
means for removing each slip sheet from said conveyor system as goods move from one conveyor section to the next.

14. The system of claim 13 wherein means for removing each layer of goods and each slip sheet from a pallet is a vacuum hood.

15. The system of claim 13 wherein means for placing each layer of goods and each slip sheet onto a conveyor section is a vacuum hood.

16. The system of claim 13 further comprising means for recycling said slip sheet.

17. The system of claim 13 further comprising means for placing each layer of goods and each slip sheet into a staging area.

18. The system of claim 17 further comprising means for removing each layer of goods and each slip sheet from said staging area.

19. A method for processing palletized goods in which a slip sheet divides each layer of goods on a pallet, said method comprising the steps of:
removing each layer of goods and each slip sheet from a pallet using vacuum power exerted by a vacuum hood;
placing goods and each slip sheet onto a conveyor system; and
removing each slip sheet from said conveyor system.

20. The method of claim 19 wherein said conveyor system is comprised of two or more conveyor sections.

21. The method of claim 19 wherein said slip sheet is a corrugated divider.

22. The method of claim 19 further comprising placing goods in a staging area prior to placing goods onto a conveyor system.

23. The method of claim 22 further comprising removing said goods from said staging area.
